(19) United States
(12) Patent Application Publication
(10) Pub. No.: US 2020/0134746 A1
(43) Pub. Date: Apr. 30, 2020

(54) METHOD AND SYSTEM FOR DETERMINATION OF PRICING OF AN ACCOMMODATION FACILITY

(71) Applicant: Ruptub Solutions Private Limited, Bengaluru (IN)

(72) Inventors: Abhishek TIWARI, Nagpur (IN); Chaitanya SANGANI, Kakinada (IN); Jasjot Singh MAAN, Mohali (IN); Raghotham SRIPADRAJ, Bangalore (IN)

(73) Assignee: Ruptub Solutions Private Limited, Bengaluru (IN)

(21) Appl. No.: 16/399,912

(22) Filed: Apr. 30, 2019

(30) Foreign Application Priority Data
Oct. 30, 2018 (IN) 201841040973

(51) Int. Cl. G06Q 50/12; G06Q 30/02; G06Q 10/02

(52) U.S. Cl. CPC G06Q 50/12; G06Q 10/02; G06Q 30/0283

(57) ABSTRACT

The present disclosure provides a system to determine an optimal price of an accommodation facility. The system fetches a first historical data and obtains a first seasonality data associated with the accommodation facility. Further, the system receives a clickstream data and collects a first set of data associated with the accommodation facility. Also, the system obtains a second set of data associated with one or more accommodation facilities similar to the accommodation facility. In addition, the system extracts a competitor data from the obtained second set of data associated with the one or more accommodation facilities similar to the accommodation facility. Also, the system generates a signal to determine an optimal price of the accommodation facility based on the fetched first historical data, the obtained first seasonality data, the received clickstream data, the collected first set of data and the extracted competitor data.

### TECHNICAL FIELD

The present disclosure relates to the field of financial management, and in particular, relates to a method and system for determination of pricing of an accommodation facility.

### INTRODUCTION

Hospitality industry provides comfortable paid-lodging on a short-term basis. The accommodation facilities provided by the hospitality industry ranges from modest-quality mattress in a small room to large suites having high-quality beds and other accommodation facilities. Further, hotel ratings are often used to classify hotels according to their quality. There are different sized beds in a particular room that usually alters final price of the room. The pricing of a hotel room is based on the hotel rating, the accommodation facilities as well as the above mentioned parameters. The aim of any hotelier is to maximize revenue generated by the hotel owned by the hotelier. The revenue can be increased by getting more occupancy of people in the hotel. Also, the revenue can be increased by increasing pricing of rooms of the hotel. However, increasing the price of rooms of the hotel has certain limitations. The first limitation is to determine the amount of price that must be increased in order to increase the revenue generated from the hotel. The price has to be increased in such a way that it should not impact occupancy of the hotel. Also, there is a competition from other hotel chains in the market that try to fetch new customers by giving them lucrative schemes and offers. The price has to be increased in such a way that the increased price is still affordable than the price offered by the competitors. In light of the above mentioned discussion, there is a constant need to determine optimal price of various types of rooms provided by the hotel.

### SUMMARY

In a first example, a computer-implemented method is provided. The computer-implemented method to determine price of an accommodation facility to optimize revenue generated by the accommodation facility. The computer-implemented method includes a first step to fetch a first historical data associated with the accommodation facility at an accommodation facility pricing system with a processor. The computer-implemented method includes another step to obtain a first seasonality data associated with the accommodation facility at the accommodation facility pricing system with the processor. The computer-implemented method includes yet another step to receive a clickstream data associated with the accommodation facility at the accommodation facility pricing system with the processor. The computer-implemented method includes yet another step to collect a first set of data associated with the accommodation facility at the accommodation facility pricing system with the processor. The computer-implemented method includes yet another step to obtain a second set of data associated with one or more accommodation facilities similar to the accommodation facility at the accommodation facility pricing system with the processor. The computer-implemented method includes yet another step to extract a competitor data from the obtained second set of data associated with the one or more accommodation facilities similar to the accommodation facility at the accommodation facility pricing system with the processor. The computer-implemented method includes yet another step to generate a signal by a signal generator circuitry embedded inside a computing device hosting the accommodation facility pricing system with the processor.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method to determine price of an accommodation facility to optimize revenue generated by the accommodation facility. The method includes a first step to fetch a first historical data associated with the accommodation facility at an accommodation facility pricing system. The method includes another step to obtain a first seasonality data associated with the accommodation facility at the accommodation facility pricing system. The method includes yet another step to receive a clickstream data associated with the accommodation facility at the accommodation facility pricing system. The method includes yet another step to collect a first set of data associated with the accommodation facility at the accommodation facility pricing system. The method includes yet another step to obtain a second set of data associated with one or more accommodation facilities similar to the accommodation facility at the accommodation facility pricing system. The method includes yet another step to extract a competitor data from the obtained second set of data associated with the one or more accommodation facilities similar to the accommodation facility at the accommodation facility pricing system. The method includes yet another step to generate the signal by the signal generator circuitry embedded inside the computing device hosting the accommodation facility pricing system.

In a third example, a non-transitory computer-readable storage medium is provided. The non-transitory computer-readable storage medium encodes computer executable instructions that, when executed by at least one processor, performs a method to determine price of an accommodation facility to optimize revenue generated by the accommodation facility. The method includes a first step to fetch a first historical data associated with the accommodation facility at an accommodation facility pricing system. The method includes another step to obtain a first seasonality data associated with the accommodation facility at the accommodation facility pricing system. The method includes yet another step to receive a clickstream data associated with the accommodation facility at the accommodation facility pricing system. The method includes yet another step to collect a first set of data associated with the accommodation facility at the accommodation facility pricing system. The method includes yet another step to obtain a second set of data associated with one or more accommodation facilities similar to the accommodation facility at the accommodation facility pricing system. The method includes yet another step to extract a competitor data from the obtained second set of data associated with the one or more accommodation facilities similar to the accommodation facility at the accommodation facility pricing system. The method includes yet another step to generate a signal by a signal generator circuitry embedded inside a computing device hosting the accommodation facility pricing system.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment for determining price of an accommodation facility, in accordance with various embodiments of the present disclosure;

FIG. 2 illustrates an example of a geographical region for determining price of a first accommodation facility, in accordance with various embodiments of the present disclosure;

FIG. 3A illustrates a flowchart for determining price of the accommodation facility, in accordance with various embodiments of the present disclosure;

FIG. 3B illustrates a flowchart for determining price of the accommodation facility, in accordance with various embodiments of the present disclosure; and

FIG. 4 illustrates a block diagram of a computing device, in accordance with various embodiments of the present disclosure.

There may be additional structures described in the description that are not depicted in the drawings, and the absence of such depictions should not be considered as an omission of such design from the specification.

### DETAILED DESCRIPTION

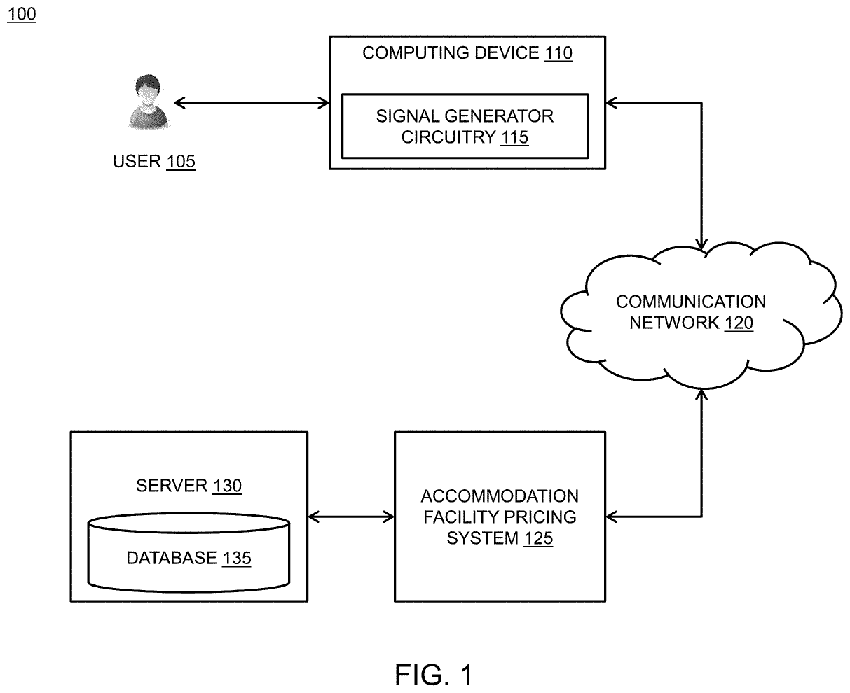

FIG. 1 illustrates an interactive computing environment 100 for determining price of an accommodation facility, in accordance with various embodiments of the present disclosure. The interactive computing environment 100 includes a user 105, a computing device 110, a signal generator circuitry 115, a communication network 120, an accommodation facility pricing system 125, a server 130, and a database 135.

The interactive computing environment 100 includes the user 105. The user 105 is any person who wants to determine price of the accommodation facility. In an embodiment of the present disclosure, the accommodation facility is an already constructed accommodation facility. In another embodiment of the present disclosure, the accommodation facility is under construction. In yet another embodiment of the present disclosure, the accommodation facility is a newly constructed accommodation facility. In an embodiment of the present disclosure, the user 105 is any person who wants to determine price of a single room of the accommodation facility. In an embodiment of the present disclosure, the accommodation facility refers to any place, building, organization, institute, skyscraper, room, a plurality of rooms or building in which someone may live or stay for a short period of time. In another embodiment of the present disclosure, the accommodation facility includes a hotel, a guesthouse, a camp site, a holiday home, communal accommodation, village hotel, other accommodation and the like. In an embodiment of the present disclosure, the accommodation facility includes various branches of the accommodation facility. In another embodiment of the present disclosure, the user 105 is any person who wants to determine price of one or more rooms of the accommodation facility. In yet another embodiment of the present disclosure, the user 105 is any person who wants to determine price of an entire floor of the accommodation facility. In yet another embodiment of the present disclosure, the user 105 is any person who wants to determine price of one or more floors of the accommodation facility. In yet another embodiment of the present disclosure, the user 105 is any person who wants to determine price of the entire accommodation facility. In an example, the user 105 wants to determine optimal price of the accommodation facility to be charged from one or more users.

The one or more users may be persons who want to stay in the accommodation facility for a limited period of time. In an example, the limited period of time includes a day, a night, a plurality of days, a plurality of nights and the like. In an embodiment of the present disclosure, the one or more users want to know price of the floor of the accommodation facility. In another embodiment of the present disclosure, the one or more users want to know price of the one or more floors of the accommodation facility. In yet another embodiment of the present disclosure, the one or more users want to know price of the room of the accommodation facility. In yet another embodiment of the present disclosure, the one or more users want to know price of the one or more rooms of the accommodation facility. In yet another embodiment of the present disclosure, the one or more users want to know price of the accommodation facility.

The user 105 is associated with the computing device 110. The computing device 110 is any smart device that mainly comprises a display, camera and network connectivity. In an embodiment of the present disclosure, the computing device 110 is a portable computing device. In an example, the portable computing device includes laptop, smartphone, tablet, PDA and the like. In another embodiment of the present disclosure, the computing device 110 is a fixed computing device. In an example, the fixed computing device includes a desktop, a workstation PC and the like.

The computing device 110 performs computing operations based on a suitable operating system installed inside the computing device 110. In general, the operating system is system software that manages computer hardware and software resources and provide common services for computer programs. In addition, the operating system acts as an interface for software installed inside the computing device 110 to interact with hardware components of the computing device 110. In an embodiment of the present disclosure, the operating system installed inside the computing device 110 is a mobile operating system. In an embodiment of the present disclosure, the computing device 110 performs computing operations based on any suitable operating system designed for portable computing device. In an example, the mobile operating system includes but may not be limited to Windows operating system from Microsoft, Android operating system from Google, iOS operating system from Apple, Symbian operating system from Nokia, Bada operating system from Samsung Electronics and BlackBerry operating system from BlackBerry. However, the operating system is not limited to above mentioned operating systems. In an embodiment of the present disclosure, the computing device 110 operates on any version of particular operating system of above mentioned operating systems.

In another embodiment of the present disclosure, the computing device 110 performs computing operations based on any suitable operating system designed for fixed computing device. In an example, the operating system installed inside the computing device 110 is Windows from Microsoft. In another example, the operating system installed inside the computing device 110 is Mac from Apple. In yet another example, the operating system installed inside the computing device 110 is Linux based operating system. In yet another example, the operating system installed inside the computing device 110 may be one of UNIX, Kali Linux, and the like. However, the operating system is not limited to above mentioned operating systems.

In an embodiment of the present disclosure, the computing device 110 operates on any version of Windows operating system. In another embodiment of the present disclosure, the computing device 110 operates on any version of Mac operating system. In another embodiment of the present disclosure, the computing device 110 operates on any version of Linux operating system. In yet another embodiment of the present disclosure, the computing device 110 operates on any version of particular operating system of the above mentioned operating systems.

In an embodiment of the present disclosure, the computing device 110 includes an advanced vision display panel. The advanced vision display panel includes OLED, AMOLED, Super AMOLED, Retina display, Haptic touchscreen display and the like. In another embodiment of the present disclosure, the computing device 110 includes a basic display panel. The basic display panel includes but may not be limited to LCD, IPS-LCD, capacitive touchscreen LCD, resistive touchscreen LCD, TFT-LCD and the like.

The computing device 110 is connected to the communication network 120. The communication network 120 provides medium to the computing device 110 to connect to the accommodation facility pricing system 125. Also, the communication network 120 provides network connectivity to the computing device 110. In an example, the communication network 120 uses protocol to connect the computing device 110 to the accommodation facility pricing system 125. The communication network 120 connects the computing device 110 to the accommodation facility pricing system 125 using a plurality of methods. The plurality of methods used to provide network connectivity to the computing device 110 includes 2G, 3G, 4G, Wifi and the like.

In an embodiment of the present disclosure, the communication network 120 may be any type of network that provides internet connectivity to the computing device 110. In an embodiment of the present disclosure, the communication network 120 is a wireless mobile network. In another embodiment of the present disclosure, the communication network 120 is a wired network with a finite bandwidth. In yet another embodiment of the present disclosure, the communication network 120 is combination of the wireless and the wired network for optimum throughput of data transmission. In yet another embodiment of the present disclosure, the communication network 120 is an optical fiber high bandwidth network that enables high data rate with negligible connection drops.

Further, the computing device 110 embeds the signal generator circuitry 115. The computing device 110 embeds the signal generator circuitry 115 to trigger a signal for communicating information between the associated systems in real time. In an embodiment of the present disclosure, the signal generator circuitry 115 generates the signal to trigger one or more hardware components associated with the computing device 110. The one or more hardware components are triggered for one or more purposes. The one or more purposes include but are not limited to fetch a first historical data, obtain a first seasonality data, receive a clickstream data, collect a first set of data, obtain a second set of data, extract a competitor data from the second set of data, determine price of the accommodation facility, to perform specific operation and the like. The one or more purposes include generating the signal based on requirement of the accommodation facility pricing system 125.

Further, the interactive computing environment 100 includes the accommodation facility pricing system 125. The computing device 110 connects with the accommodation facility pricing system 125 through the communication network 120. The computing device 110 connects with the accommodation facility pricing system 125 by utilizing one or more applications. The one or more applications include but may not be limited to a web browser, a mobile application, a widget, an API and web applets. In general, each application of the one or more applications provide a graphical user interface to the computing device 110. In addition, the web browser installed on the computing device 110 is any web browser. In an example, the web browser includes Google Chrome, Mozilla Firefox, Opera, UC Web, Safari, Internet Explorer, Microsoft Edge and the like. Further, the web browser installed on the computing device 110 runs on any version of the respective web browser of the above mentioned web browsers. In addition, the mobile application installed inside the computing device 110 may be based on any mobile platform. In an example, the mobile platform includes but may not be limited to Android, iOS, BlackBerry, Symbian, Windows and Bada. Further, the mobile application installed inside the computing device 110 runs on any version of respective mobile platform of the above mentioned mobile platforms.

The accommodation facility pricing system 125 fetches the first historical data associated with the accommodation facility. In an embodiment of the present disclosure, the accommodation facility pricing system 125 fetches the first historical data associated with the accommodation facility in real-time. The first historical data includes past data associated with the accommodation facility. In an embodiment of the present disclosure, the first historical data includes past occupancy data, past pricing data and past miscellaneous data associated with the accommodation facility. In an example, the first historical data includes number of people that earlier occupied the accommodation facility on particular day, price of the accommodation facility in the past based on the number of people accommodated, and the like. The first historical data is fetched from a first region of a geographical region. The geographical region is physical area that includes the accommodation facility and the one or more associated accommodation facilities. In an embodiment of the present disclosure, the geographical region refers to a physical region that includes one or more accommodation facilities in that region. In another embodiment of the present disclosure, the geographical region refers to the region that supports habitation of human beings. In an example, the geographical region includes an area, colony, sector, village, tehsil, city, state, town, country, continent, union territory or combination thereof. In an embodiment of the present disclosure, the first region of the geographical region is simply one or more sub-regions of the geographical region. In another embodiment of the present disclosure, the first region of the geographical region is one or more sub-regions of the geographical region encapsulating the accommodation facility.

The accommodation facility pricing system 125 fetches the first historical data from a plurality of sources. The plurality of sources include but not limited to at least one of a data warehouse, the database 135, third-party databases, social-networking sites, and web-based platforms. In general, the data warehouse is a large store of data accumulated from a wide range of sources within a company and used to guide management decisions. In general, the database 135 is a collection of information that is organized so that it can be easily accessed, managed and updated. In an embodiment of the present disclosure, the third-party databases are external databases that contain data associated with the accommodation facility. In another embodiment of the present disclosure, the third-party databases are external databases that contain data associated with the one or more accommodation facilities. In general, social networking sites are an online platform that allows users to create public profiles and interact with other users on the website. Further, the term web-based platform here refers to one or more websites on the Internet that provide data associated with the accommodation facility and the one or more accommodation facilities.

The accommodation facility pricing system 125 obtains the first seasonality data associated with the accommodation facility in real-time. In an embodiment of the present disclosure, the accommodation facility pricing system 125 obtains the first seasonality data associated with the accommodation facility in real-time. The first seasonality data includes data associated with the accommodation facility based on a plurality of seasons. In addition, the plurality of seasons include spring, summer, monsoon, autumn, pre-winter, and winter. The first seasonality data includes occupancy data, pricing data, and miscellaneous data associated with the accommodation facility based on the plurality of seasons. In an example, the first seasonality data includes number of people staying in the accommodation facility during winter season, number of people staying in the accommodation facility during summer season, and the like. In another example, the first seasonality data includes number of people staying in the accommodation facility during Christmas week, number of people staying in the accommodation facility during summer vacation period, and the like. Also, the first seasonality data is obtained from the plurality of sources.

The first seasonality data is obtained from a second region of the geographical region. The second region of the geographical region includes one or more sub-regions from union of the first region and the geographical region. In an example, the second region may include any sub-region of the geographical region as well as the first region itself or one or more sub-regions of the geographical region. In an embodiment of the present disclosure, the user 105 utilizes the accommodation facility pricing system 125 to select the second region of the geographical region. In another embodiment of the present disclosure, the second region of the geographical region is set identical to the first region of the geographical region by default. In an embodiment of the present disclosure, the second region of the geographical region is encapsulated around the accommodation facility.

The accommodation facility pricing system 125 receives the clickstream data associated with the accommodation facility in real-time. In an embodiment of the present disclosure, the accommodation facility pricing system 125 receives the clickstream data associated with the accommodation facility in real-time. The clickstream data is received from the plurality of sources. In an embodiment of the present disclosure, the clickstream data is received from one or more web-based platforms associated with the facility. In an example, the clickstream data includes number of people visiting the web-based platforms associated with the accommodation facility, number of people currently staying in the accommodation facility, number of booked rooms of the accommodation facility, number of occupied rooms of the accommodation facility, and the like. In an embodiment of the present disclosure, the clickstream data is data associated with the web-based platforms and the social-networking sites.

In an example, the clickstream data includes booking of the accommodation facility received through the plurality of sources. In another example, the clickstream data includes number of rooms that are already occupied of the accommodation facility. In yet another example, the clickstream data includes data of booked rooms received from booking window associated with the accommodation facility. In yet another example, the clickstream data includes data of occupied rooms received from booking window associated with the accommodation facility. In yet another example, the clickstream data includes number of visitors that visited window booking associated with the accommodation facility.

The accommodation facility pricing system 125 collects a first set of data associated with the accommodation facility. In an embodiment of the present disclosure, the accommodation facility pricing system 125 collects the first set of data associated with the accommodation facility in real-time. The first set of data is collected from the plurality of sources. The accommodation facility pricing system 125 collects the first set of data based on a plurality of factors. The plurality of factors include at least one of location, capacity, room typology, services offered, room service, client type, room facilities, sales channels, online reputation, brand name, marketing and sales strategy, hotel ratings, price strategy, and the like. The first set of data is associated with the accommodation facility based on the plurality of factors.

In an example, the first set of data includes location details of the accommodation facility. In another example, the first set of data includes capacity of the accommodation facility. In yet another example, the first set of data includes room typology of the accommodation facility. In yet another example, the first set of data includes various services offered by the accommodation facility. In yet another example, the first set of data includes room services offered by the accommodation facility. In yet another example, the first set of data includes various types of clients associated with the accommodation facility. In yet another example, the first set of data includes various room facilities offered by the accommodation facility to specific clients. In yet another example, the first set of data includes various sales channels associated with the accommodation facility. In yet another example, the first set of data includes information about online reputation of the accommodation facility. In yet another example, the first set of data includes information about brand name of the accommodation facility. In yet another example, the first set of data includes marketing and sales strategy of the accommodation facility. In yet another example, the first set of data includes rating of the accommodation facility. In yet another example, the first set of data includes price strategy of the accommodation facility.

The accommodation facility pricing system 125 obtains the second set of data associated with the one or more accommodation facilities similar to the accommodation facility. In an embodiment of the present disclosure, the accommodation facility pricing system 125 obtains the second set of data associated with the one or more accommodation facilities similar to the accommodation facility in real-time. The second set of data is obtained from the plurality of sources. The second set of data is obtained from a third region of the geographical region. The third region of the geographical region includes one or more sub-regions from union of the second region and the geographical region. In an embodiment of the present disclosure, the third region of the geographical region is identical to the second region of the geographical region and the first region of the geographical region by default. In another embodiment of the present disclosure, the third region of the geographical region is set by the user 105 at the accommodation facility pricing system 125. In an embodiment of the present disclosure, the third region of the geographical region encapsulates around the accommodation facility. In an example, the accommodation facility pricing system 125 obtains the second set of data from nearby hotels if the accommodation facility is one of hotel. In another example, the accommodation facility pricing system 125 obtains the second set of data from nearby guesthouses if the accommodation facility is one of guesthouse.

In an embodiment of the present disclosure, the second set of data includes all information associated with the one or more accommodation facilities similar to the accommodation facility. In an example, the second set of data includes pricing information of the one or more accommodation facilities similar to the accommodation facility. In another example, the second set of data includes occupancy information of the one or more accommodation facilities similar to the accommodation facility. In yet another example, the second set of data includes various services offered by the one or more accommodation facilities similar to the accommodation facility.

The accommodation facility pricing system 125 extracts the competitor data from the obtained second set of data associated with the one or more accommodation facilities similar to the accommodation facility. In an embodiment of the present disclosure, the accommodation facility pricing system 125 extracts the competitor data from the obtained second set of data associated with the one or more accommodation facilities similar to the accommodation facility in real-time. The competitor data is a subset of the second set of data. The competitor data is extracted from the second set of data. The competitor data is data of those one or more accommodation facilities that are highly identical to be treated as competitor to the accommodation facility. In an embodiment of the present disclosure, the competitor data is extracted based on the plurality of factors. In an embodiment of the present disclosure, the accommodation facility pricing system 125 extracts the competitor data in real-time. The competitor data includes a second historical data, a second seasonality data, a pricing data and miscellaneous data extracted from the second set of data associated with the one or more accommodation facilities similar to the accommodation facility.

Further, the second historical data includes past data associated with the one or more accommodation facilities similar to the accommodation facility. The second seasonality data includes data associated with the one or more accommodation facilities similar to the accommodation facility. The pricing data includes pricing data associated with the one or more accommodation facilities similar to the accommodation facility. The miscellaneous data includes all other relevant data associated with the one or more accommodation facilities similar to the accommodation facility. In an embodiment of the present disclosure, the competitor data includes all data and information extracted from the second set of data that is associated with the one or more accommodation facilities similar to the accommodation facility. In an example, the competitor data includes price of rooms in the one or more accommodation facilities similar to the accommodation facility extracted from the second set of data. In another example, the competitor data includes number of people that occupied the one or more accommodation facilities similar to the accommodation facility extracted from the second set of data. In yet another example, the competitor data includes number of people that occupied the one or more accommodation facilities similar to the accommodation facility in a particular season extracted from the second set of data. In yet another example, the competitor data includes offers, discounts and coupons provided by the one or more accommodation facilities similar to the accommodation facility extracted from the second set of data.

The accommodation facility pricing system 125 extracts the competitor data from the obtained second set of data based on mapping of the first historical data, the first seasonality data, the clickstream data, and the first set of data with the second set of data. The mapping is done based on a plurality of factors. The plurality of factors include but may not be limited to at least one of location, capacity, room typology, services offered, room service, client type, room facilities, sales channels, online reputation, brand name, marketing and sales strategy, ratings, and price strategy. In an example, the competitor data includes the one or more accommodation facilities having nearby location as that of the accommodation facility. In another example, the competitor data includes the one or more accommodation facilities having similar capacity as that of the accommodation facility. In yet another example, the competitor data includes the one or more accommodation facilities having similar room typology as that of the accommodation facility. In yet another example, the competitor data includes the one or more accommodation facilities having similar services offered as that of the accommodation facility. In yet another example, the competitor data includes the one or more accommodation facilities having similar room service as that of the accommodation facility. In yet another example, the competitor data includes the one or more accommodation facilities that focus on same client type as that of the accommodation facility. In yet another example, the competitor data includes the one or more accommodation facilities having similar room facilities as that of the accommodation facility. In yet another example, the competitor data includes the one or more accommodation facilities having similar sales channels as that of the accommodation facility. In yet another example, the competitor data includes the one or more accommodation facilities having similar online reputation as that of the accommodation facility. In yet another example, the competitor data includes the one or more accommodation facilities having similar marketing and sales strategy as that of the accommodation facility. In yet another example, the competitor data includes the one or more accommodation facilities having similar ratings as that of the accommodation facility. In yet another example, the competitor data includes the one or more accommodation facilities having similar price strategy as that of the accommodation facility.

In an embodiment of the present disclosure, the accommodation facility pricing system 125 has the first historical data, the first seasonality data, the clickstream data, the first set of data, the second set of data and the competitor data. The accommodation facility pricing system 125 has all relevant data associated with the accommodation facility. The accommodation facility pricing system 125 utilizes all above mentioned data to determine price of the accommodation facility. The price of the accommodation facility is optimal price that must be set for the accommodation facility. The price of the accommodation facility is set based on above mentioned data. In an embodiment of the present disclosure, the price of the accommodation facility refers to price of the room inside the accommodation facility. In another embodiment of the present disclosure, the price of the accommodation facility refers to price of the one or more rooms of the accommodation facility. In yet another embodiment of the present disclosure, the price of the accommodation facility refers to price of the floor of the accommodation facility. In yet another embodiment of the present disclosure, the price of the accommodation facility refers to price of the one or more floors of the accommodation facility. In yet another embodiment of the present disclosure, the price of the accommodation facility refers to price of the entire accommodation facility.

The signal generator circuitry 115 is embedded inside the computing device 110 hosting the accommodation facility pricing system 125. The signal generator circuitry 115 generates the signal to determine the optimal price of the accommodation facility. The determination of the optimal price of the accommodation facility is based on the fetched first historical data, the obtained first seasonality data, the received clickstream data, the collected first set of data and the extracted competitor data from the second set of data. The accommodation facility pricing system 125 analyzes the above mentioned data properly to determine the optimal price of the accommodation facility. The determination of the optimal price of the accommodation facility includes determining price of the single room, double room, rooms with specific-sized beds, one or more types of rooms, a single floor, one or more floors or a combination thereof.

The first region of the geographical region is virtual region that can be created in real-time dynamically. In an embodiment of the present disclosure, the user 105 has capability to create the first region of the geographical region. In another embodiment of the present disclosure, the first region of the geographical region is created by the accommodation facility pricing system 125. In an embodiment of the present disclosure, the first region of the geographical region can be created of any geometrical shape and size. In an embodiment of the present disclosure, the first region of the geographical region is circular in shape. In another embodiment of the present disclosure, the first region of the geographical region is rectangular in shape. In yet another embodiment of the present disclosure, the first region of the geographical region is triangular in shape. In yet another embodiment of the present disclosure, the first region of the geographical region is of any possible geometrical shape and size.

The second region of the geographical region is virtual region that can be created in real-time dynamically. In an embodiment of the present disclosure, the user 105 has capability to create the second region of the geographical region. In another embodiment of the present disclosure, the second region of the geographical region is created by the accommodation facility pricing system 125. In an embodiment of the present disclosure, the second region of the geographical region can be created of any geometrical shape and size. In an embodiment of the present disclosure, the second region of the geographical region is circular in shape. In another embodiment of the present disclosure, the second region of the geographical region is rectangular in shape. In yet another embodiment of the present disclosure, the second region of the geographical region is triangular in shape. In yet another embodiment of the present disclosure, the second region of the geographical region is of any possible geometrical shape and size.

The third region of the geographical region is virtual region that can be created in real-time dynamically. In an embodiment of the present disclosure, the user 105 has capability to create the third region of the geographical region. In another embodiment of the present disclosure, the third region of the geographical region is created by the accommodation facility pricing system 125. In an embodiment of the present disclosure, the third region of the geographical region can be created of any geometrical shape and size. In an embodiment of the present disclosure, the third region of the geographical region is circular in shape. In another embodiment of the present disclosure, the third region of the geographical region is rectangular in shape. In yet another embodiment of the present disclosure, the third region of the geographical region is triangular in shape. In yet another embodiment of the present disclosure, the third region of the geographical region is of any possible geometrical shape and size.

In an embodiment of the present disclosure, the determination of the optimal price of the accommodation facility is done based on artificial neural network models. In another embodiment of the present disclosure, the determination of the optimal price of the accommodation facility is done based on machine learning algorithms. In yet another embodiment of the present disclosure, the determination of the optimal price of the accommodation facility is done based on artificial intelligence algorithms. In yet another embodiment of the present disclosure, the determination of the optimal price of the accommodation facility is done manually by the user 105. In an embodiment of the present disclosure, the accommodation facility pricing system 125 accommodates the first historical data, the first seasonality data, the clickstream data, the first set of data, the second set of data and the competitor data using distance-based filtering algorithms. In another embodiment of the present disclosure, the accommodation facility pricing system 125 accommodates the first historical data, the first seasonality data, the clickstream data, the first set of data, the second set of data and the competitor data using content-based filtering algorithms. In general, content-based filtering is based on a description of item and a profile of user's preferences. In yet another embodiment of the present disclosure, the accommodation facility pricing system 125 accommodates the first historical data, the first seasonality data, the clickstream data, the first set of data, the second set of data and the competitor data using collaborative filtering algorithms. In general, collaborative filtering is based on collecting and analyzing a large amount of information on users' behaviors, activities or preferences and predicting what users will like based on their similarity to other users.

Further, the interactive computing environment 100 includes the server 130. The accommodation facility pricing system 125 is connected with the server 130. In general, the server 130 is a computer program that provides service to another computer programs. In general, the server 130 may provide various functionalities or services, such as sharing data or resources among multiple clients, performing computation for a client and the like. In an example, the server 130 may be at least one of dedicated server, cloud server, virtual private server and the like. However, the server 130 is not limited to above mentioned servers.

Further, the server 130 includes the database 135. In general, the database 135 is a collection of information that is organized so that it can be easily accessed, managed and updated. In an example, the database 135 may be one of at least hierarchical database, network database, relational database, object-oriented database and the like. The database 135 provides storage location to the first historical data, the first seasonality data, the clickstream data, the first set of data, the second set of data, the competitor data, and the like. In an embodiment of the present disclosure, the database 135 provides storage location to all the data and information required by the accommodation facility pricing system 125. In an example, the database 135 is connected to the server 130. The server 130 stores data in the database 135. The server 130 interacts with the database 135 to retrieve the stored data.

In an embodiment of the present disclosure, the accommodation facility pricing system 125 stores the first historical data, the first seasonality data, the clickstream data, the first set of data, the second set of data and the competitor data in the database 135 associated with the accommodation facility pricing system 125. The accommodation facility pricing system 125 does storing in real-time. In an embodiment of the present disclosure, the accommodation facility pricing system 125 updates the first historical data, the first seasonality data, the clickstream data, the first set of data, the second set of data and the competitor data in the database 135 associated with the accommodation facility pricing system 125. The accommodation facility pricing system 125 does updating in real-time.

In an embodiment of the present disclosure, the accommodation facility pricing system 125 determines the optimal price of the accommodation facility to optimize revenue generated by the accommodation facility. The revenue of the accommodation facility can be increased in a plurality of methods. The revenue of the accommodation facility may be increased by increasing occupancy of the accommodation facility. In addition, the revenue of the accommodation facility may be increased by increasing price of the accommodation facility. The accommodation facility pricing system 125 determines the optimal price of the accommodation facility to increase the revenue generated by the accommodation facility.

In another embodiment of the present disclosure, the accommodation facility pricing system 125 determines the optimal price of the accommodation facility to maximize profit generated by the accommodation facility. In yet another embodiment of the present disclosure, the accommodation facility pricing system 125 determines the optimal price of the accommodation facility to optimize revenue and maximize profit generated by the accommodation facility. In yet another embodiment of the present disclosure, the accommodation facility pricing system 125 determines the optimal price of the accommodation facility to maximize occupancy of the accommodation facility. In an example, the accommodation facility pricing system 125 determines the optimal price of the accommodation facility to increase the revenue generated by the accommodation facility X till the accommodation facility X reaches an occupancy of about 50%. The accommodation facility pricing system 125 updates the determined optimal price of the accommodation facility X so as to maximize the profit generated by the accommodation facility X once the accommodation facility exceeds the occupancy of 50%.

In an embodiment of the present disclosure, the accommodation facility pricing system 125 determines the optimal price of the accommodation facility based on Average Room Rate (hereinafter, ARR) of the accommodation facility. In general, ARR is a metric widely used in the hospitality industry to measure the average rate per available room. In another embodiment of the present disclosure, the accommodation facility pricing system 125 determines the optimal price of the accommodation facility based on Average Daily Rate (hereinafter, ADR) of the accommodation facility. In general, ADR is a metric widely used in the hospitality industry to indicate the average realized room rental per day. In yet another embodiment of the present disclosure, the accommodation facility pricing system 125 determines the optimal price of the accommodation facility based on Revenue per Available Room (hereinafter, RevPAR) of the accommodation facility. In general, RevPAR is a performance metric widely used in the hospitality industry that is calculated by multiplication of ADR and the occupancy of hotel. In yet another embodiment of the present disclosure, the accommodation facility pricing system 125 determines the optimal price of the accommodation facility based on performance metrics such as ADR, ARR, RevPAR and the like.

In an embodiment of the present disclosure, the accommodation facility pricing system 125 determines the optimal price of the accommodation facility based on one or more aspects. The one or more aspects include number of rooms already occupied, number of rooms already booked, number of rooms available to be booked, number of rooms available to be occupied, advance booking of the one or more rooms, number of hours left for booking of the one or more rooms, and the like. In an embodiment of the present disclosure, the accommodation facility pricing system 125 determines the optimal price of the accommodation facility based on how much advance the booking is received through booking window associated with the accommodation facility. In another embodiment of the present disclosure, the accommodation facility pricing system 125 determines the optimal price of the accommodation facility based on how many number of rooms are left that are available to be booked. In another embodiment of the present disclosure, the accommodation facility pricing system 125 determines the optimal price of the accommodation facility based on number of hours left for the booking of the one or more rooms for a particular day or time or to complete a specific target. In an example, the accommodation facility pricing system 125 determines different price of the accommodation facility Y if a user X books the accommodation facility Y in 3 days advance. In another example, the accommodation facility pricing system 125 determines different price of the accommodation facility Y if the user X books the accommodation facility in 7 days advance. In another example, the accommodation facility pricing system 125 determines higher price of the accommodation facility if there are more number of hours left for the completion of particular day or specific time or specific target. In yet another example, the accommodation facility pricing system 125 determines lesser price of the one or more rooms of the accommodation facility when the number of hours left for the completion of particular day or specific time or specific target is less. In yet another example, the accommodation facility pricing system 125 determines higher price of the one or more rooms of the accommodation facility when the number of the one or more rooms available to be booked are more. In yet another example, the accommodation facility pricing system 125 determines lower price of the one or more rooms of the accommodation facility when the number of the one or more rooms available to be booked are less.

In an embodiment of the present disclosure, the accommodation facility pricing system 125 creates one or more user profiles of the one or more users. The one or more user profiles of the one or more users are created based on a third set of data. The third set of data includes personal information of the one of more users, demographic information of the one or more users, and the like. In addition, the third set of data includes data of one or more devices associated with the one or more users. In addition, the one or more user profiles are stored in the database 135. Also, the one or more user profiles are updated in real-time. Further, the accommodation facility pricing system 125 determines the optimal price of the accommodation facility based on the third set of data stored in the one or more user profiles of the one or more users. In an example, a user profile of the user X contains information that the device owned by the user X is an iPhone running on iOS operating system. In addition, a user profile of a user Y contains information that the device owned by the user Y is a Motorola phone running on Android operating system. The accommodation facility pricing system 125 determines different prices for the different users X and Y based on the smartphones used by the different users. In an example, the accommodation facility pricing system 125 may determine higher price of room of the accommodation facility to the iPhone user (user X) because of higher price of the iPhone. In another example, the accommodation facility pricing system 125 may determine lower price of room of the accommodation facility to the Motorola user (user Y) because of lower price of the Motorola phone.

In an embodiment of the present disclosure, the accommodation facility pricing system 125 determines different optimal prices of the accommodation facility for the one or more users based on one or more update channels used by the one or more devices of the one or more users. In an embodiment of the present disclosure, the one or more update channels include text message updates, push notification application updates, browser-based updates and the like. In an example, the accommodation facility pricing system 125 determines different optimal price of the accommodation facility for notification sent through the text message update to the one or more devices of the one or more users.

In an embodiment of the present disclosure, the accommodation facility pricing system 125 determines the optimal price of the accommodation facility based on prices of other similar accommodation facilities listed on one or more OTA's. The term OTA stands for Online Travel Agency. In general, an OTA is a travel website that specializes in the sale of travel products to consumers. The one or more OTA's may list different prices of the similar accommodation facilities based on conditions such as business agreements, percentage of commission, amount of traffic, confirmed bookings and the like. In an embodiment of the present disclosure, the accommodation facility pricing system 125 determines the optimal price of the accommodation facility based on the above mentioned conditions.

In an example, the user 105 has to determine the optimal price of particular room of a hotel. The user 105 uses the computing device 110 to connect to the accommodation facility pricing system 125. Further, the computing device 110 uses the communication network 120 to connect to the accommodation facility pricing system 125. The accommodation facility pricing system 125 fetches the first historical data, obtains the first seasonality data, receives the clickstream data, collects the first set of data, obtains the second set of data and extracts the competitor data from the second set of data. The accommodation facility pricing system 125 analyzes the above mentioned data to determine optimal price of the particular room of the hotel. In addition, the signal generator circuitry 115 embedded inside the computing device 110 determines the optimal price of the particular room of the hotel based on above mentioned data.

The accommodation facility pricing system 125 may be implemented using the single computing device 110, or a network of computing devices, including cloud-based computer implementations. The computing device 110 is preferably server class computers including one or more high-performance computer processors and random access memory, and running an operating system such as LINUX or variants thereof. The operations of the accommodation facility pricing system 125 as described herein can be controlled through either hardware or through computer programs installed in non-transitory computer readable storage devices such as solid state drives or magnetic storage devices and executed by the processors to perform the functions described herein. The database 135 is implemented using non-transitory computer readable storage devices, and suitable database management systems for data access and retrieval. The accommodation facility pricing system 125 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

It is shown in FIG. 1 that the user 105 use the computing device 110 to connect to the accommodation facility pricing system 125; however, those skilled in the art would appreciate that there may be more number of users connecting to the accommodation facility pricing system 125. In addition, it is shown in FIG. 1 that the computing device 110 is used by the user 105 to connect to the accommodation facility pricing system 125; however, those skilled in the art would appreciate that there may be more number of computing devices used by more number of users to connect to the accommodation facility pricing system 125.

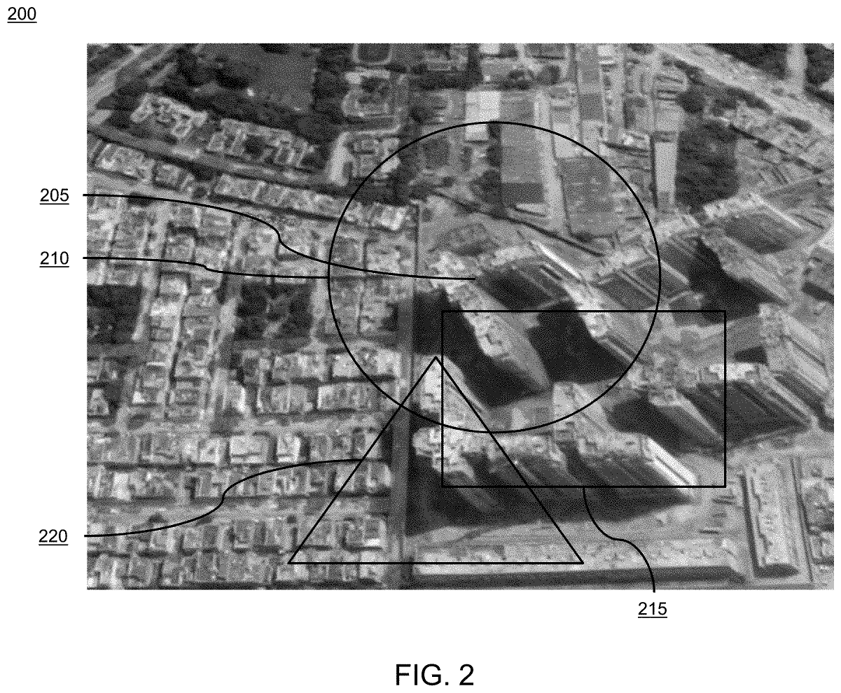

FIG. 2 illustrates an example of a geographical region 200 for determining price of a first accommodation facility 205, in accordance with various embodiments of the present disclosure. The geographical region 200 includes the first accommodation facility 205, a first region 210, a second region 215 and a third region 220. The first region 210 is circular in shape. The second region 215 is rectangular in shape. The third region 220 is triangular in shape. In an example, the accommodation facility pricing system 125 fetches the first historical data from various branches of the first accommodation facility 205 that comes under the first region 210. Also, the accommodation facility pricing system 125 obtains the first seasonality data from various branches of the first accommodation facility 205 that comes under the second region 215. In addition, the accommodation facility pricing system 125 receives the clickstream data from various branches of the first accommodation facility 205. Further, the accommodation facility pricing system 125 collects the first set of data associated with the first accommodation facility 205. Furthermore, the accommodation facility pricing system 125 obtains the second set of data associated with the one or more accommodation facilities similar to the first accommodation facility 205 that comes under the third region 220. Moreover, the accommodation facility pricing system 125 extracts the competitor data from the one or more accommodation facilities similar to the first accommodation facility 205 that comes under the third region 220. Further, the signal generator circuitry 115 generates the signal to determine the optimal price of the first accommodation facility 205 based on hardware-run algorithms. (as mentioned above)

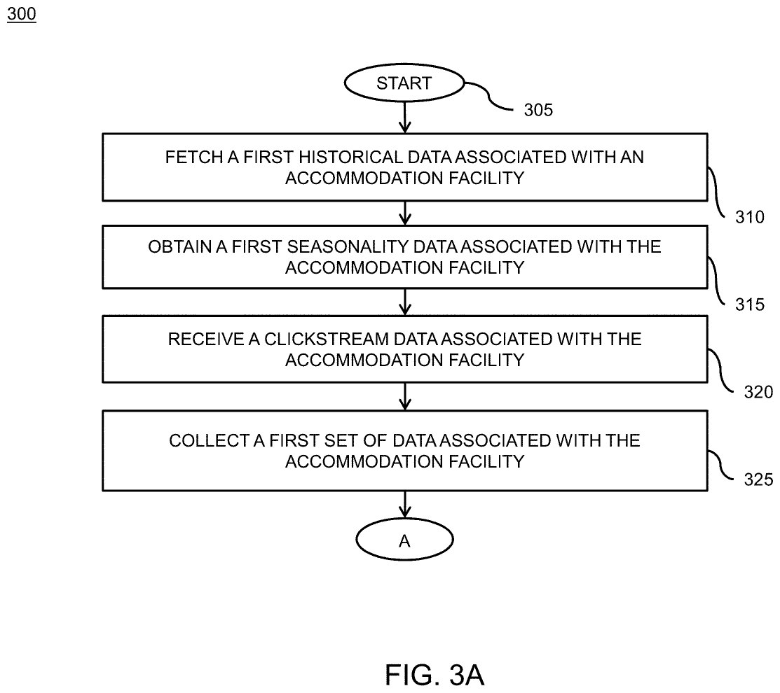

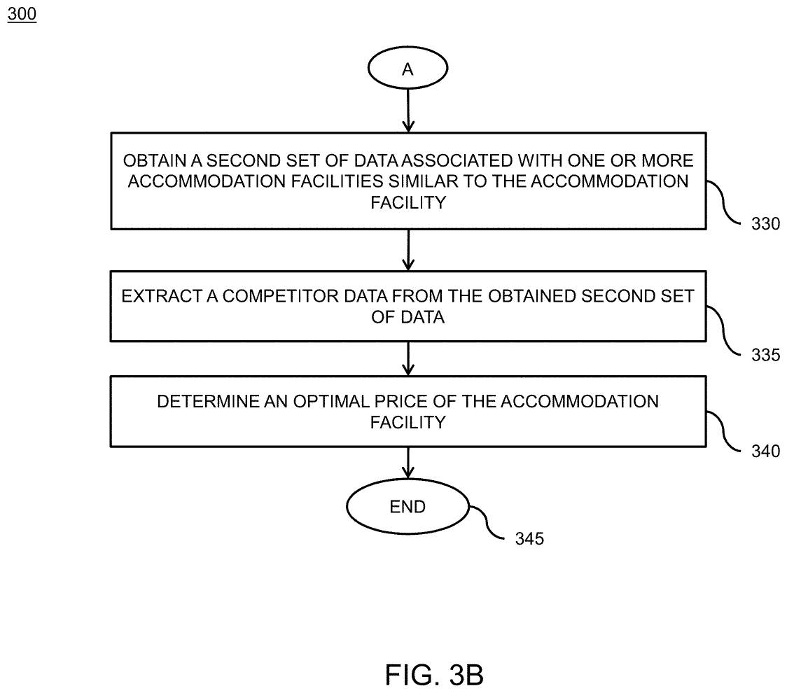

FIG. 3A and FIG. 3B illustrates a flow chart 300 of a method for determining price of the accommodation facility to optimize revenue generated by the accommodation facility, in accordance with various embodiments of the present disclosure. It may be noted that in order to explain the method steps of the flowchart 300, references will be made to the elements explained in FIG. 1. The flow chart 300 starts at step 305. At step 310, the accommodation facility pricing system 125 fetches the first historical data associated with the accommodation facility, wherein the first historical data is fetched from the first region of the geographical region. At step 315, the accommodation facility pricing system 125 obtains the first seasonality data associated with the accommodation facility, wherein the first seasonality data is obtained from the second region of the geographical region. At step 320, the accommodation facility pricing system 125 receives the clickstream data associated with the accommodation facility. At step 325, the accommodation facility pricing system 125 collects the first set of data associated with the accommodation facility. At step 330, the accommodation facility pricing system 125 obtains the second set of data associated with the one or more accommodation facilities similar to the accommodation facility. At step 335, the accommodation facility pricing system 125 extracts the competitor data from the obtained second set of data associated with the one or more accommodation facilities similar to the accommodation facility. At step 340, the accommodation facility pricing system 125 determines the optimal price of the accommodation facility. The flow chart 300 terminates at step 345. It may be noted that the flowchart 300 is explained to have above stated process steps; however, those skilled in the art would appreciate that the flowchart 300 may have more/less number of process steps which may enable all the above stated embodiments of the present disclosure.

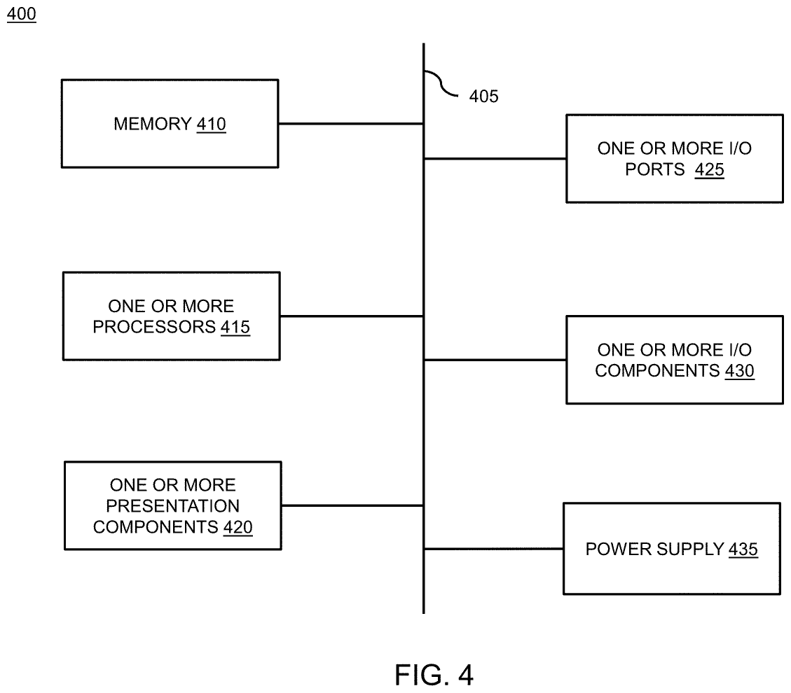

FIG. 4 illustrates a block diagram of the computing device 110, in accordance with various embodiments of the present disclosure. The computing device 110 includes a bus 405 that directly or indirectly couples the following devices: memory 410, one or more processors 415, one or more presentation components 420, one or more input/output (I/O) ports 425, one or more input/output components 430, and an illustrative power supply 435. The bus 405 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 110 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 110 typically includes a variety of computer-readable media. The computer-readable media can be any available media that can be accessed by the computing device 110 and includes both volatile and nonvolatile media, removable and non-removable media. By way of example, and not limitation, the computer-readable media may comprise computer readable storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the computing device 110. The computer storage media includes, but is not limited to, non-transitory computer readable storage medium that stores program code and/or data for longer periods of time, such as secondary or persistent long term storage, like read only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 110.

The memory 410 includes computer-storage media in the form of volatile and/or nonvolatile memory. The memory 410 may be removable, non-removable, or a combination thereof. Exemplary hardware devices include solid-state memory, hard drives, optical-disc drives, etc. The computing device 110 includes the one or more processors 415 that read data from various entities such as the memory 410 or I/O components 430. The one or more presentation components 420 present data indications to a user or other device. Exemplary presentation components include a display device, speaker, printing component, vibrating component, etc. The one or more I/O ports 425 allow the computing device 110 to be logically coupled to other devices including the one or more I/O components 430, some of which may be built in. Illustrative components include a microphone, joystick, game pad, satellite dish, scanner, printer, wireless device, etc.

What is claimed:

1. A computer-implemented method for determining price of an accommodation facility to optimize revenue generated by the accommodation facility, the computer-implemented method comprising:
fetching, at an accommodation facility pricing system with a processor, a first historical data associated with the accommodation facility, wherein the first historical data is fetched from a first region of a geographical region, wherein the first historical data is fetched from a plurality of sources;
obtaining, at the accommodation facility pricing system with the processor, a first seasonality data associated with the accommodation facility, wherein the first seasonality data is obtained from a second region of the geographical region, wherein the first seasonality data is obtained from the plurality of sources;
receiving, at the accommodation facility pricing system with the processor, a clickstream data associated with the accommodation facility, wherein the clickstream data is received from the plurality of sources;
collecting, at the accommodation facility pricing system with the processor, a first set of data associated with the accommodation facility, wherein the first set of data is collected from the plurality of sources;
obtaining, at the accommodation facility pricing system with the processor, a second set of data associated with one or more accommodation facilities similar to the accommodation facility, wherein the second set of data is obtained from a third region of the geographical region, wherein the second set of data is obtained from the plurality of sources;
extracting, at the accommodation facility pricing system with the processor, a competitor data from the obtained second set of data associated with the one or more accommodation facilities similar to the accommodation facility, wherein the competitor data comprises a second historical data, a second seasonality data, a pricing data and miscellaneous data associated with the one or more accommodation facilities similar to the accommodation facility; and
a signal generator circuitry embedded inside a computing device hosting the accommodation facility pricing system with the processor, wherein the signal generator circuitry generates a signal for determining an optimal price of the accommodation facility based on the fetched first historical data, the obtained first seasonality data, the received clickstream data, the collected first set of data and the extracted competitor data from the second set of data, wherein the determination is done in real-time.

2. The computer-implemented method as recited in claim 1, wherein the determination of pricing of the accommodation facility comprises determining price of a single room, a double room, rooms with specific-sized beds, one or more types of rooms, a single floor, one or more floors or a combination thereof.

3. The computer-implemented method as recited in claim 1, wherein the accommodation facility comprises at least one of a hotel, a guesthouse, a camp site, a holiday home, communal accommodation, village hotel, and other accommodation.

4. The computer-implemented method as recited in claim 1, wherein the geographical region is physical area that comprises the accommodation facility and the one or more associated accommodation facilities, wherein the first region of the geographical region comprises one or more sub-regions of the geographical region, wherein the second region of the geographical region comprises one or more sub-regions from union of the first region and the geographical region, and wherein the third region of the geographical region comprises one or more sub-regions from union of the second region and the geographical region.

5. The computer-implemented method as recited in claim 1, wherein the first seasonality data comprises data associated with the accommodation facility based on a plurality of seasons, wherein the plurality of seasons comprises spring, summer, monsoon, autumn, pre-winter, and winter, wherein the first seasonality data comprises occupancy data, pricing data, and miscellaneous data associated with the accommodation facility.

6. The computer-implemented method as recited in claim 1, wherein the first historical data comprises past data associated with the accommodation facility, wherein the first historical data comprises past occupancy data, past pricing data and past miscellaneous data associated with the accommodation facility.

7. The computer-implemented method as recited in claim 1, wherein the competitor data is a subset of the second set of data, wherein the competitor data is extracted from the second set of data.

8. The computer-implemented method as recited in claim 1, wherein the accommodation facility pricing system with the processor extracts the competitor data from the obtained second set of data based on mapping of the first historical data, the first seasonality data, the clickstream data, and the first set of data with the second set of data, wherein the mapping is done based on a plurality of factors.

9. The computer-implemented method as recited in claim 8, wherein the plurality of factors comprises of at least one of location, capacity, room typology, services offered, room service, client type, room facilities, sales channels, online reputation, brand name, marketing and sales strategy, ratings, and price strategy.

10. A computer system comprising:
one or more processors;
a signal generator circuitry embedded inside a computing device for generating a signal; and
a memory coupled to the one or more processors, the memory for storing instructions which, when executed by the one or more processors, cause the one or more processors to perform a method for determining price of an accommodation facility to optimize revenue generated by the accommodation facility, the method comprising:
fetching, at an accommodation facility pricing system, a first historical data associated with the accommodation facility, wherein the first historical data is fetched from a first region of a geographical region, wherein the first historical data is fetched from a plurality of sources;
obtaining, at the accommodation facility pricing system, a first seasonality data associated with the accommodation facility, wherein the first seasonality data is obtained from a second region of the geographical region, wherein the first seasonality data is obtained from the plurality of sources;
receiving, at the accommodation facility pricing system, a clickstream data associated with the accommodation facility, wherein the clickstream data is received from the plurality of sources;
collecting, at the accommodation facility pricing system, a first set of data associated with the accommodation facility, wherein the first set of data is collected from the plurality of sources;
obtaining, at the accommodation facility pricing system, a second set of data associated with one or more accommodation facilities similar to the accommodation facility, wherein the second set of data is obtained from a third region of the geographical region, wherein the second set of data is obtained from the plurality of sources;
extracting, at the accommodation facility pricing system, a competitor data from the obtained second set of data associated with the one or more accommodation facilities similar to the accommodation facility, wherein the competitor data comprises a second historical data, a second seasonality data, a pricing data and miscellaneous data associated with the one or more accommodation facilities similar to the accommodation facility; and
the signal generator circuitry embedded inside the computing device hosting the accommodation facility pricing system, wherein the signal generator circuitry generates the signal for determining an optimal price of the accommodation facility based on the fetched first historical data, the obtained first seasonality data, the received clickstream data, the collected first set of data and the extracted competitor data from the second set of data, wherein the determination is done in real-time.

11. The computer system as recited in claim 1, wherein the determination of pricing of the accommodation facility comprises determining price of a single room, a double room, rooms with specific-sized beds, one or more types of rooms, a single floor, one or more floors or a combination thereof.

12. The computer system as recited in claim 1, wherein the accommodation facility comprises at least one of a hotel, a guesthouse, a camp site, a holiday home, communal accommodation, village hotel, and other accommodation.

13. The computer system as recited in claim 1, wherein the geographical region is physical area that comprises the accommodation facility and the one or more associated accommodation facilities, wherein the first region of the geographical region comprises one or more sub-regions of the geographical region, wherein the second region of the geographical region comprises one or more sub-regions from union of the first region and the geographical region, and wherein the third region of the geographical region comprises one or more sub-regions from union of the second region and the geographical region.

14. The computer system as recited in claim 1, wherein the plurality of sources comprises at least one of a data warehouse, a database, third-party databases, social-networking sites, and web-based platforms.

15. The computer system as recited in claim 1, wherein the first seasonality data comprises data associated with the accommodation facility based on a plurality of seasons, wherein the plurality of seasons comprises spring, summer, monsoon, autumn, pre-winter, and winter, wherein the first seasonality data comprises occupancy data, pricing data, and miscellaneous data associated with the accommodation facility.

16. The computer system as recited in claim 1, wherein the first historical data comprises past data associated with the accommodation facility, wherein the first historical data comprises past occupancy data, past pricing data and past miscellaneous data associated with the accommodation facility.

17. The computer system as recited in claim 1, wherein the competitor data is a subset of the second set of data, wherein the competitor data is extracted from the second set of data.

18. The computer system as recited in claim 1, wherein the accommodation facility pricing system extracts the competitor data from the obtained second set of data based on mapping of the first historical data, the first seasonality data, the clickstream data, and the first set of data with the second set of data, wherein the mapping is done based on a plurality of factors.

19. The computer system as recited in claim 9, wherein the plurality of factors comprises of at least one of location, capacity, room typology, services offered, room service, client type, room facilities, sales channels, online reputation, brand name, marketing and sales strategy, ratings, and price strategy.

20. A non-transitory computer-readable storage medium encoding computer executable instructions that, when executed by at least one processor, performs a method for determining price of an accommodation facility to optimize revenue generated by the accommodation facility, the method comprising:
fetching, at an accommodation facility pricing system, a first historical data associated with the accommodation facility, wherein the first historical data is fetched from a first region of a geographical region, wherein the first historical data is fetched from a plurality of sources;
obtaining, at the accommodation facility pricing system, a first seasonality data associated with the accommodation facility, wherein the first seasonality data is obtained from a second region of the geographical region, wherein the first seasonality data is obtained from the plurality of sources;
receiving, at the accommodation facility pricing system, a clickstream data associated with the accommodation facility, wherein the clickstream data is received from the plurality of sources;
collecting, at the accommodation facility pricing system, a first set of data associated with the accommodation facility, wherein the first set of data is collected from the plurality of sources;
obtaining, at the accommodation facility pricing system, a second set of data associated with one or more accommodation facilities similar to the accommodation facility, wherein the second set of data is obtained from a third region of the geographical region, wherein the second set of data is obtained from the plurality of sources;
extracting, at the accommodation facility pricing system, a competitor data from the obtained second set of data associated with the one or more accommodation facilities similar to the accommodation facility, wherein the competitor data comprises a second historical data, a second seasonality data, a pricing data and miscellaneous data associated with the one or more accommodation facilities similar to the accommodation facility; and
a signal generator circuitry embedded inside a computing device hosting the accommodation facility pricing system, wherein the signal generator circuitry generates a signal for determining an optimal price of the accommodation facility based on the fetched first historical data, the obtained first seasonality data, the received clickstream data, the collected first set of data and the extracted competitor data from the second set of data, wherein the determination is done in real-time.
